(19) United States
(12) Patent Application Publication
(10) Pub. No.: US 2014/0266004 A1
(43) Pub. Date: Sep. 18, 2014

(54) ELECTRIC VEHICLE CHARGING SYSTEM

(71) Applicant: Zevtron, LLC, San Diego, CA (US)

(72) Inventor: Robert George Andrews, JR., Carlsbad, CA (US)

(73) Assignee: Zevtron, LLC, San Diego, CA (US)

(21) Appl. No.: 13/830,697

(22) Filed: Mar. 14, 2013

(51) Int. Cl. B60L 11/18

(52) U.S. Cl. CPC B60L 11/1838
USPC 320/104; 320/109; 320/108; 320/137

(57) ABSTRACT

A method comprises connecting to a charging server; connecting to an authorization management system; receiving a charging request from a charging server, the charging request identifying an electric charging device requested to be used to charge an electric vehicle; transmitting an authorization request to the authorization management system for the electric charging device to be used to charge the electric vehicle; receiving an authorization response from the authorization management system authorizing the electric charging device to be used to charge the electric vehicle; and transmitting an authorization instruction to the charging server to charge the electric vehicle using the electric charging device.

### TECHNICAL FIELD

The present invention relates to charging systems for electric vehicles.

### DESCRIPTION OF THE RELATED ART

Electric vehicles and plug-in hybrid electric vehicles (collectively, EVs) are becoming more and more commonly accepted and utilized by the general public due to their environmentally friendly attributes such as lack of emissions and fossil fuel use. However, just as common internal combustion vehicles need to be refueled, EVs need to be recharged once the battery charge is drained.

Unfortunately, there is a general lack of supporting infrastructure for EVs. Typically, EV recharging is performed at EV users' homes, and charging stations for public use are scarce. Charging stations that are accessible to the public are usually standalone stations, require a long time to charge, and are inconvenient to use. Additionally, most public charging stations require the EV user to sign up or register with the charging station operator. Alternatively, the EV user may use a credit card that is embedded with a “touch-and-pay”system, or other token such as a fob or RFID tag that assigned to a user or car. Generally, chargers cannot be customized according to the EV users' charging needs or requirements. Instead, charging begins when the connection is established, and ends when the battery is fully charged or disconnected.

### BRIEF SUMMARY OF EMBODIMENTS

In some embodiments of the systems and methods described herein, a vehicle charging system may be customized for use in a parking structure environment. in further embodiments, an EV charging system may be configured to transfer charge to an EV by using capacitors or induction coils. In still further embodiments, the EV charging system allows a different user to disconnect the connection between EV and charging station if the previous user's charging needs are satisfied.

According to an embodiment of the systems and methods described herein, an EV charging system for charging an EV in a parking structure environment is provided, comprising an electric charging device located proximal to a parking space and configured to provide an electrical connection to an EV. A token is configured to be associated with the EV or the driver. The token may be used to identify the EV, such as, for example, to uniquely identify the EV or to identify the EV as a group of EVs associated with an account. The EV charging system may comprise an attribute management system configured to determine attribute data associated with the parking/charging session. For example a time management system may compute or measure time data indicating the length of time the EV is parked in a given spot, time data indicating the amount of time an EV is charged, and time/date information indicating day, date and time of day during which a vehicle is parked. The time data can be associated with the token and this information used, for example, to determine type of charging applied (for example, based on time of day, date, etc.), and to associate the charging event to an account associated with the token for accounting, billing and payment management purposes.

The electric vehicle charging system may also comprise a charging management system configured to associate the token with the electric charging device. For example, this can be used to gather and monitor charge data indicating the amount of charge consumed by the vehicle, the rate of charge used by the vehicle, and other attributes that can be used by the system or infrastructure. The charge data can be associated with the token and this information used, for example, to determine rate of charging used (for example, different charging rates may be billed at different billing rates), the amount of charge transferred to the user, and to associate the charging attributes to the account associated with the token for accounting, billing and payment management purposes.

The electric vehicle charging system may also comprise a payment management system configured to retrieve the time and charging data associated with the token and determine a monetary value based on the time and charging data. This can be used, for example, to bill the account associated with the token, which can be, for example, an individual account or a group account. Examples of group accounts may include a corporate account, government account and so on.

in further embodiments, an electric charging device may be configured to provide an electrical connection to an EV. The electric charging device may comprise a connector configured to provide a charging connection to an EV and a display configured to display EV charging information.

In further embodiments, the above-described systems and methods can be used in a number of parking environments such as, for example, with parking lots, parking structures, street parking and so on. The attribute management systems can be centralized or parts of it can be distributed as warranted by the parking environment. For example, parking kiosks can be used to provide a local centralized attribute management facility to manage charging events for a number of parking spaces/charging stations communicably connected to the kiosk(s).

In various embodiments, a method of charging an EV in a parking structure is provided. The method may comprise determining a parking duration as a length of time that an EV parks in a parking structure, providing an EV user with a token associated with the EV, associating the parking duration with the token, associating the token with an electric charging device and providing a charging connection with the EV. The method may further comprise charging the EV via the charging connection, determining an amount of charge transferred to the EV, associating the amount of charge with the token, retrieving the parking duration and the amount of charge from the token, and providing the EV user with payment information and a method of payment based on the retrieved parking duration and the retrieved amount of charge.

In further embodiments, a capacitor-based EV charging system is provided. Such a system may comprise a first capacitor coupled to a local power grid, an electric charging device coupled to the first capacitor, where the electric charging device is configured to charge the first capacitor and to couple to an EV, a second capacitor located within the EV configured to couple to the electric charging device, and a battery within the EV coupled to the second capacitor.

In further embodiments, an induction-based EV charging system is provided. The system includes a plurality of road induction coils disposed below a driving surface and coupled to a local power grid, a vehicle induction coil located inside an EV, a battery within the EV coupled to the vehicle induction coil, and a tracking system configured to track the EV as it moves from one road induction coil to another road induction coil and to monitor the amount of charge transferred to the EV.

In further embodiments, a courtesy feature coupled to a centralized EV charging information display system is provided. The system may comprise a central terminal configured to retrieve an EV identification, a plurality of electric charging devices coupled to the central terminal with each electric charging device configured to provide a connection with an EV, and a plurality of displays coupled to the central terminal configured to display charging information of the electric charging devices. The central terminal may be further configured to receive data related to the EV user's charging needs and disengage the connection upon satisfaction of the EV user's charging needs.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 depicts a parking structure installed with an exemplary EV charging system in accordance with various embodiments of the systems and methods described herein.

FIG. 2A is a block diagram illustrating an exemplary interconnectedness of various systems, in accordance with various embodiments of the systems and methods described herein, as applied to a parking structure.

FIG. 2B illustrates deployment of various systems described with respect to FIG. 2A.

FIG. 3 depicts an exemplary electric charging device in accordance with various embodiments of the systems and methods described herein.

FIG. 4 is a block diagram illustrating an exemplary method for charging an EV in accordance with various embodiments of the systems and methods described herein.

FIG. 5 is a block diagram illustrating an exemplary capacitor based EV charging system in accordance with various embodiments of the systems and methods described herein.

FIG. 6A is a block diagram illustrating an exemplary induction based EV charging system in accordance with various embodiments of the systems and methods described herein.

FIG. 6B depicts an exemplary induction based EV charging system in accordance with various embodiments of the systems and methods described herein, as applied to a taxi waiting area.

FIG. 7 is a block diagram illustrating an exemplary centralized EV charging information display system in accordance with various embodiments of the systems and methods described herein.

FIG. 8 is an illustration of the process of the centralized EV charging information display system's courtesy feature in accordance with various embodiments of the systems and methods described herein,

FIG. 9 is a block diagram illustrating a configuration of an exemplary system in accordance with various embodiments of the systems and methods described herein.

### DETAILED DESCRIPTION OF THE EMBODIMENTS OF THE INVENTION

FIG. 1 illustrates an exemplary EV charging system implemented in a parking structure or other parking facility 100, in accordance with an embodiment of the systems and methods described herein. An EV 108 enters the parking structure via an entry system 102 and parks at a parking space 104. In some embodiments, the EV 108 can be a pure electric vehicle, a plug-in hybrid with an electric motor and an internal combustion engine or other vehicle configured to utilize an electric charge. An electric charging device 106 may be installed proximal to a parking space 104. In some embodiments, electric charging devices 106 can be installed at each parking space 104, as shown, or a single electric charging device 106 can be installed at a location proximal to several sparking spaces 104 to connect to multiple EVs 108. In some embodiments, the EV user connects the EV 108 with the electric charging device 106 to charge the EV. For example, the user may plug a charging cable into the associated receptacle in the vehicle for charging in other embodiments, inductive charging may be provided using inductive coils or other cordless charging techniques to transfer the charge without the charging cable. In various embodiments, token information can be transferred via a hard wired or wireless connection as described in more detail below.

Upon completion, the EV user exits the parking facility 100 via the exit system 110 after paying either at the electric charging device 106, at the exit system 110, or at a parking kiosk 112. Payment can be made by cash, credit card, debt card, payment token, near field communication payment, text message, a prearranged billing arrangement (such as a hotel bill), or other payment techniques. In some embodiments, payment is billed to the user's associated account by payment infrastructure rather than requiring the user to pay by cash or bank card at the time of transaction. Various billing and payment methods that can be used with this exemplary system are described in more detail below.

In other implementations, payment does not occur. For example, the EV user may comprise an authorized user of parking facility 100, or the EV may be an authorized vehicle for parking at facility 100. In these implementations, the token information may be used to verify authorization and to allocate charging information to particular authorized users.

Also note that embodiments can be used such as in street parking or other parking facilities without entry and exit systems, where the attributes, such as time attributes and charge attributes, can be measured by a charging system proximal to the spot or using a kiosk system, or a combination thereof.

FIG. 2A provides a more detailed example of how an exemplary EV charging system 200, similar to the one illustrated in FIG. 1, operates. The EV charging system 200 comprises three main interconnected systems: a time management system 202, a charging management system 206, and an authorization management system 204.

The time management system 202 monitors the duration of the EV's stay in the parking structure. In some embodiments, the time management system may be coupled to the entry and exit systems 102, 110. When the EV 108 enters the parking structure via the entry system 102, the entry system 102 dispenses a token 208. The token 208 may be anything capable of identifying or associating the EV 108, or the driver or owner, or other party responsible for payment, with the charging system. For example, the token may comprise an identification number, a hotel room number, a driver's license number, a physical ticket, an RFID tag, a near-field communication device, or a radio transponder. In some implementations, the token 208 may comprise a parking ticket, which may include a machine-readable ticket number. The token may be dispensed by a token dispenser (e.g., a ticket machine) coupled to a boom gate or other entry mechanism. The token 208 is used to associate the EV or the EV's user with a particular charging device to allow use of the particular charging device to be allocated to the EV or EV's user. The token 208 may be associated with the EV in various manners—such as, through the possession of the token by the EV's driver, storage or correlation of EV identification information with token identification information, or through other techniques.

In other embodiments, an RFID tag, transponder, parking sticker, or credit card or other identifiable token may be employed. The entry system 102 determines the date and time date of entry and associates this time with the token 208. For example, an RFID or other wireless communication device may be included in the vehicle to identify the vehicle (or the user's account) upon the vehicle's entry to and exit from the vehicle at the parking facility.

The time management system 202 also determines the parking duration., in some embodiments, the parking duration may be determined using the time of departure as compared to the time of entry. For example, the EV user can swipe or scan the token 208 at a sensor (magnetic, optical, RF or otherwise) coupled to the time management system 202, which registers that time as the exit time. In further embodiments, the EV user can approach the exit system 110, which recognizes the token 208 and determines the time of departure. The exit system 110 may be manually operated by an attendant, who determines the entry and departure times. Based on the time of entry and departure, the time management system 202 determines the duration of the EV's stay. This information may then be transmitted to the authorization management system 204. Authorization management system 204 may determine whether the EV or user is authorized to use the parking or charging facilities. In some embodiments, the authorization occurs through payment, which can be determined based on duration of parking. Different parking rates can be applied to different times of day or different dates. For example, premium rates may apply in commercial zones during business hours.

In further embodiments, the token 208 may be a magnetic card, smart card, or a key card commonly used in hotels or other businesses that provide overnight accommodations. For example, the magnetic card or key card, which is already associated with a specific room number, may be further associated with an EV. The association can be performed by entering, touching or swiping the magnetic card or key card at the charging management system. The association can further be performed at the reception desk of the hotel. If the EV user uses the hotel parking structure and charges his or her vehicle while staying at the hotel, using the magnetic card or key card used in the hotel as the token may enable the EV user to consolidate the hotel bill, the parking bill, and the charging fee into one bill. The EV user can pay the consolidated bill at time of check out. The same concept can be applied to office buildings that use RFID tags, key cards or other tokens to allow building, office and elevator access.

In the illustrated embodiment, the charging management system 206 is configured to connect to the EV to transfer an electric charge, determine the amount and rate of charge transferred to the EV, or the time length of the charge, and provide charge to the EV based on the charging needs of the user. In various embodiments, the charging management system 206 may be coupled to an electric charging device 106 or may be integrated into an electric charging device 106. The token 208 may be further associated with the charging management system 206. The token 208 may be associated in a variety of ways. For example, the token 208 may be associated by waving or placing the token 208 proximal to an RFID reader coupled to the charging management system 206. The RFID reader may be configured to identify the token 208 dispensed at the entry system 102. In another example, the EV user may insert the parking ticket or credit card that was dispensed at the entry system 102 into a token reader that is coupled to the charging management system 206 (such as for example, at charging device 106 or kiosk 112). In the hotel, business or other like embodiments, the user may scan or swipe his or her key card at the charging device 106 or kiosk 112. Alternatively, the user may be able to enter his account or room number into the charging device 106 or charge management system 205, or text or otherwise send his account or room number to the payment management system 204. Likewise, a transponder or other token associated with the vehicle can be used to wirelessly between the vehicle 108 and charging management system 206 either wirelessly or through a wired connection. The wireless connection may be via an RFID tag or other transponder of the vehicle or through data communications through an inductive charging link. The wired connection may be, for example, included with the hard-wired electrical charge connection. This can be via a separate hard-wired link, or through data modulated on the charging link.

The charging management system 206 may further provide a receptacle configured to receive a connector from the EV, or provide a connector that connects to the EV. In some embodiments, the receptacle may be an electrical outlet configured to receive a connector from the EV. The outlet may be configured to be compatible with a standardized EV connector or customized to conform to a specific EV manufacturer's standard.

In further embodiments, a locking system may be implemented to prevent a third party from disconnecting the connector and charging a different EV. The locking system may be a mechanical, or an electric system. In a mechanical system, the EV user may be given a lock with a key or a combination so that the EV user is the only person capable of unlocking the connection. In an electrical system, the locking system identifies the EV via the connection and provides charge only to that specific EV. The electrical system may also provide a physical locking mechanism that is controlled by the system. The control can be based on the ID of vehicle or user and can be configured to unlock when charging is complete.

In embodiments using an electrical system, the charging apparatus can be unlocked electronically by the system either physically (to allow disengagement, for example) or electronically (for example, to stop charging, to no longer associate charging to the given ID, etc.). Accordingly, such a system can be used in an environment where a charging apparatus is shared by multiple parking spaces. When a user's charge is complete, but his or her remains in the spot, the system can be electronically ‘unlocked’ and physically unlocked and freed up for use by others. Therefore, another user entering a nearby spot can locate an available, unlocked charging apparatus at another vehicle and relocate the charging connection to his or her vehicle and begin charging.

The charging management system 206 may be further configured to monitor the amount of charge transferred to the EV. This information may be stored within a memory in the charging management system 206 or directly transferred to the payment management system 204 and stored.

Furthermore, the charging management system 206 may be configured to receive data regarding the EV user's specific charging needs. Exemplary charging needs may include, but are not limited to, the level of charge desired (e.g., level I, II or III), duration of charge, desired percentage of battery charged, and dynamic charging. The charging needs can be entered via an input device coupled to the charging management system 202. A level of charge may be the voltage used to charge the EV. For instance, level I charging may refer to using 120V AC and 16 Ampere outlets. Level II charging may refer to using 208-240 V AC and 12-80 Ampere outlets, Level III charging may refer to using very high voltages of 300-600 V DC and currents in the hundreds of Amperes. Other levels may be accommodated as appropriate.

Duration of charging may relate to how long the EV user wants to charge his or her EV. A user may indicate that he or she would like to charge the vehicle for a set amount of time instead charging the vehicle battery completely. Further, the user can set the duration or time of the charge so that the charging occurs at a certain part of the day in order to charge when electricity is less expensive. For example, for long term or overnight parking, a user may specify a time of departure and select an option for charging at off-peak times. The system may then determine the amount of charge required, the time required to complete the charge and the best time slots at which to perform this charge so as to minimize the cost of the charge for the user. This can also serve to manage peak loading on the system. Additional discounts can be provided to the user for allowing such charging-time flexibility to encourage this option allowing the system the opportunity to manage peak demands. Likewise, if a consumer needs to depart by a certain time, that can also be specified so the system can perform the charging (if possible) within the given time constraints.

In some embodiments, the user can indicate a desired percentage of battery charged. For example, if a user only needs the EV to be charged enough to get him or her to a certain destination—to 80%, for example—this information can be specified to the charging management system 206.

Dynamic charging may allow a user to set the charging to be performed according to some specific needs, such as only charging the vehicle when electricity charges are at their lowest or below a user or otherwise set threshold. This may also have the advantage of modulating charging to minimize load on systems and reduce electricity cost to the parking lot operator.

In some embodiments, the charge management system 206 may also be configured to communicate with the EV user's computer, smart phone, or other electronic device 210. In such embodiments, the EV user may use the communication with the charge management system 206 to modify the charging needs without having to call an operator at the parking structure. Since the token 208 is associated with the user's EV and electric charging management system, the user can access the charging management system 206 by entering the number or indicia of identification of the token 208. Also, in some embodiments the smart phone or other electronic device can serve as the token. Further, the system can communicate status and other to the user via the smart phone or other electronic device.

If the authorization management system 204 manages payment, the system 204 may collect information from the time and charging management systems 202, 206 and determine a monetary value based on the information. The payment management system 204 may determine the duration of the EV's stay at the parking structure and the amount of charge transferred. The payment management system 204 may calculate and display a monetary value, and present the user with payment options. Payment options may include cash, credit or debit cards or check. The payment management system 204 may further include a system where the user can complete the transaction using the above payment options. The system may be located in the electric charging device 106, at the exit system 110 or at an independent location within the parking structure. If located in the electric charging device 106, the system may display the monetary value after the EV user enters or swipes the token 208. The EV user may complete the transaction through the system using payment options mentioned above. A similar system can be applied at the exit system 110 or at any other location as an independent device.

In various embodiments, the time, charging and authorization management systems 202, 206 and 204 may be installed in the electric charging device 106 (which may be at each parking space), in a separate central kiosk 112, or in separate locations within the parking structure. When installed in the electric charging device 106, all interaction between the EV user and the system can occur at the electric charging device 106. Such an embodiment may provide each individual EV user with their own electric charging device, token reader, and so on, eliminating situations where the EV user may have to wait for another EV user to input their charging needs or complete their transaction. The EV user can associate his or her EV with the electric charging device 106, input charging needs on a display and make payments at the device or when leaving the parking structure.

The attribute management systems 202, 204, 206 may also be installed in a central kiosk 112 or distributed among the kiosk 112 and the charging system 106. In such an embodiment, interactions between the EV user and the systems occur at the central kiosk. The central kiosk may allow the user to associate the token with the electric charging device 106 by inputting the electric charging device's identification number or by entering or swiping the token. The central kiosk may also allow the EV user to input charging needs. When retrieving the vehicle, the user may complete the payment transaction at the central kiosk. The central kiosk configuration may have the advantage of making individual electric charging devices cheaper, because they can be simplified to only handle the charging functions.

In further embodiments, the attribute management systems 202, 204, 206 can be installed separately in different parts of the parking structure. For instance, the time management system 202 can be installed inside either the entry or exit systems 102, 110, the charging management system 206 can be installed inside the electric charging device 106, and the payment management system 204 can be installed inside the exit system 110. The parking structure operator will have the freedom and discretion to devise the best installation options according to individual parking structure plans.

In further embodiments, the EV charging system can be utilized in an airport parking environment, in such an environment, the EV user may have the ability to input his or her flight schedule into the charging management system 206. In some embodiments, the charging management system 206 can use this information to ensure that the EV will be charged while preferentially charging at times with lower electricity prices. In further embodiments, the user may have the ability to modify the flight schedule using his or her portable electronic device 210 or flight information may be provided by the airline systems to the attribute management systems. Thus, for example, parking demand can be managed as well as charging times and completion times.

In further embodiments, the EV charging system can be utilized for curbside parking systems. An electric charging device 106 can be installed at each parking space. The electric charging device 106 can include the time 202, charging 206 and payment management systems 204 and operate in a manner independent of the other electric charging devices 106. The attribute management systems 202, 204, 206 can also be installed in a central kiosk 112 that controls and monitors electric charging devices 106 designated and coupled to the central kiosk for a plurality of parking spaces.

In still further embodiments, the charging management system 206 is configured to interface with a user. For example, the charging management system 206 may prevent a vehicle 108 from drawing excess charge or from occupying a charging device 106 for an excessive length of time. Such prevention may comprise transmitting a warning message to device 210 (for example, via text message or email to notify the user to disconnect the vehicle 108 or incur additional charges). As another example, the charging management system 206 may transmit a notification to the user of vehicle 108 to notify that charging has completed. As another example, the charging management system 206 may transmit notification to other users of other vehicles that the vehicle 108 has completed charging, and the charging device 106 is available for use.

FIG. 28 illustrates an example embodiment implementing off-site charging management. In this example, an on-site charging server 214 is communicatively coupled to the electric charging devices 106. The on-site charging server 214 is further communicatively coupled to an off-site host server 212. In various embodiments the functions of the charging management system 206 may be divided between the on-site charging sever 214 and the off-site host server 212. In other embodiments, the charging management system 206 is the host server 212 and the on-site server 214 implements the host server's 212 instructions and provides the host server 212 information.

For example, in one embodiment, the on-site charging server 214 may be coupled to the charging devices 106 and configured to control the operation of the charging device 106 pursuant to instructions from the off-site host server 212. The server 214 may control various aspects of the charging process. For example, the server 214 may control an amount of time the vehicle 108 is connected to the charging device 106, an amount of charge provided to the vehicle 108, a rate of charge provided to the vehicle 108, a time of day that the vehicle 108 is connected to the charging device 106, a cost of electricity for charging the vehicle 108, or a length of time spent charging the vehicle 108.

The server 214 may relay information from the electric vehicle 108 (or a user of the electric vehicle 108, or an entity responsible for payment for charging the vehicle 108) to the off-site host server 212. Such information may comprise token information received by the server 214, either directly or via the charging device 106. The information may further comprise charging data, such as an amount of time the vehicle 108 is connected to the charging device 106, an amount of charge provided to the vehicle 108, a rate of charge provided to the vehicle 108, a time of day that the vehicle 108 is connected to the charging device 106, a cost of electricity for charging the vehicle 108, or a length of time spent charging the vehicle 108.

In some embodiments, the server 214 is configured to receive charging needs or preferences for the vehicle 108. The charging needs may be received from the host server 212, the management system 211, the vehicle 108, or from the user directly (for example, through a web interface). The charging needs may comprise any parameter related to the charging process, for example, speed of charging, duration of charging, level of charging, authorized price of electricity, completion time, or time of charging, in these embodiments, the server 214 is configured to control the electric charging devices 106 to implement the charging needs.

In additional embodiments, the on-site server 214 is configured to monitor the total power usage at the parking site. For example, the on-site server 214 may be coupled to the site's utility meter or other power monitor 213. The server 214 may use the information obtained from the meter 213 to control the charging process. For example, in some cases, cost of electricity is influenced by peak power draw rate during a billing period.

In some embodiments, the server 214 maintains a memory of the power draw rate during a predetermined period such as a billing period. The server 214 further maintains a memory of the current billing period's peak power draw rate. If the power used by devices 106 approaches the current period's peak power draw rate, the server 214 may reduce the charging rate of the devices 106 to avoid increasing the current billing period's peak power draw rate. Alternatively, the server 214 may reduce the charging rate of the devices 106 to avoid increasing the current billing period's peak power draw rate by some amount or percentage. In other embodiments, the host server 212 may provide charging rate limits to the server 214 according to information from the meter 213 relayed by the server 214 to the server 212. In still further embodiments, the server 214 may be coupled to other on-site systems that have transient power needs. The other on-site systems may transmit an indication of upcoming electricity usage to the server 214. In this case, the server 214 may reduce the power provided by the devices 106 to accommodate the transient power needs without increasing the current peak power draw rate.

As illustrated, the host 212 is in further communication with a management system 211. In various embodiments, the management system 211 may be on-site or off-site. In this embodiment, the management system provides the functions of time management system 202 and payment management system 204. Accordingly, the management system 211 obtains token information associated with a user or vehicle 108 and associates that token information with charging information from the host 212.

In some embodiments, the management system 211 provides the host system 212 with charging authorization. For example, the host 212 may receive a request from the server 214 to charge a particular vehicle 108 at a particular charging device 106, in this case, the host 212 may also receive token information from the user or vehicle 108. The host 212 relays the request to the management system 211 and receives an authorization or a rejection of the request. For example, management system 211 may provide EV users who have a store membership (such as a warehouse club or merchant providing a credit account) with authorization to park in their EV charging-equipped parking lots. Such authorization may be payment free or included in the cost of the store membership. As an example, a store club member may park their vehicle 108 in a particular parking stall 104 to use a particular charging device 106. The store club member may send their club member number and identification information for charging device 106 to host 212. The host 212 may then send an authorization request, including the membership number, to the management system 211 to verify that the user is authorized use the charger 106. After charging, the host 212 may send charging information associated with the membership number to the management system 211 to allow the management system 211 to maintain a record of the charging event.

In other embodiments, the management system 211 receives the charging request directly from the user or vehicle 108. For example, the management system 211 may comprise an input allowing a user to input an identifier of a charging device 106 and token information. Upon receipt of a valid token, the management system 211 may provide the host 212 with an authorization to allow the vehicle 108 to be charged at the identified device 106. As an example, a hotel guest might park their vehicle 108 in a parking stall 104 having a charging device 106. The hotel guest may then text their room number and charging device 106 identification to the management system 211. The management system 211 may then authorize the host 212 to charge the vehicle 108. The host 212 may then instruct the server 214 to charge the vehicle using charging device 106. The proprietor may then add costs of charging to the hotel bill using information retrieved from the host 212 via the management system 211.

As illustrated, the host 212 is in communication with one management system 211 and one server 214. In further implementations, the host 212 may be connected to pluralities of management systems 211 and servers 214. In some cases, the host 212 may provide charge management systems for a variety of entities, requiring separate servers 214 at parking facilities and management systems 211 to manage parking at the facilities. In other cases, large parking facilities may require multiple servers 214 to control charging. In still further cases, a management system 211 may authorize parking at multiple facilities, each facility equipped with its own server 214. For example, a grocery chain may have a management system 211 with authorization information for its members, which is connected to host 212. Each grocery store may have a server 214 connected to host 212. Accordingly, the host 212 may provide charging management for the management system 211 at a plurality of different stores.

In further embodiments, the EV charging system can be implemented as a stand-alone charger, as shown in FIG. 3. The EV system 300 comprises the electric charging device 302. The electric charging device 302 may provide a receptacle 306 or a connector 308 that connects with the EV 310. The connection can be wired or wireless. For public or shared parking, a token reader can be provided to accept token information to ID the user or vehicle for accounting purposes. The token reader can be a card reader, RFID reader, magnetic stripe reader or other token reader such as those described above. The token information can also be transferred via the wired or wireless charging link as also described above. The electric charging device 302 may include a display 304 that shows charging information. The electric charging device 302 may further incorporate the charging and the payment management systems 206, 204. The charging and payment management systems 206, 204 may perform similar functions as described herein with respect to various embodiments.

FIG. 4 illustrates an exemplary method 400 in which the EV charging system operates in a parking structure environment in accordance with some embodiments. As an EV user approaches an entry system, the time management system may identify the entry time at operation 402, associate the entry time with a token and provide the token to the EV user at operation 404. In one embodiment, the time of entry or other start time may be determined when the user parks in a spot such as, for example, via a wired or wireless token reader at the spot or at a kiosk.

Once the EV user parks the EV at a parking space, the token may be associated with the electric charging device at operation 406, which provides a connection to the EV at operation 408. The association can be made by the EV user presenting the token, through the charging connection or by other means described above. Prior to charging the EV, the charging management system may receive EV user's charging needs at operation 410 and provide charge to the EV accordingly at operation 412. The charging management system may monitor and determine the amount and level of charge transferred to the EV and provides that information to the payment system at operation 414.

When the EV user retrieves the EV, the time management system may register a departure time at operation 416 and provide that information to the payment management system at operation 418. Departure time can be measured based on when the vehicle leaves the spot or at an exit station.

Thereafter, the payment management system may determine a monetary value based on the information received from the time and charging management systems and provide this information to the EV user at operation 418. The payment system may receive payment from the EV user at operation 420 and associate the token with information that payment has been completed at operation 422. Payment can be made by the token, by bank card or other means, or by billing through an account associated with the token or vehicle ID.

Eventually, at operation 424, the EV may be allowed to leave the parking structure by depositing, scanning or otherwise presenting the token at the exit system, in other embodiments, the payment can be completed through an operator who is present in a booth at the exit system.

FIG. 5 illustrates a block diagram of an exemplary capacitor based EV charging system 500 in accordance with some embodiments, Capacitors, including ultracapacitors and supercapacitors, typically have much greater charge and discharge rates than batteries. FIG. 5 illustrates an embodiment of the invention utilizing capacitors to assist in EV charging. Within the charging station 508, multiple charging station capacitors 504 may be interconnected with each other. The interconnection can take the form of a matrix of charging station capacitors that are located underneath the charging station 508 surface. The charging station capacitors 504 may be further coupled to the local power grid 502 and an electric charging device 512. The electric charging device 512 may be configured to connect with an EV 514 and transfer charge from the charging station capacitors 504. The EV 514 may be equipped with a vehicle capacitor 518 and a battery 516. The vehicle capacitor 518 may receive the charge from the electric charging device 512 and transfers the charge to the battery 516.

In some embodiments, a central terminal 506 can be configured to monitor and control charge transfer from the local power grid 502 to the charging station capacitors 504. The central terminal 506 can be programmed to continuously charge the charging station capacitors 504 to maintain a certain charge level, or stop drawing charge if the charging station capacitors 504 are fully charged. Additionally, the charging station operator can customize the charging to meet the user's needs. This can allow the charging station operator to maintain a certain charge level of the charging station capacitors 504 independent of demand at the charging station 508. Examples of a user's charging needs may comprise cost of charge (e.g., a user may want to charge only if the rate is less than some price), speed of charge, time of day of charge, preferred percent charged, or some combination thereof.

In some embodiments, the vehicle capacitor 518 may be utilized during normal driving conditions. For example, if the battery 516 is fully charged, the vehicle capacitor 518 can be used as a secondary battery, thus increasing the range of the EV 514. As another example, the vehicle capacitor 504 may be utilized in braking energy reclamation.

The electric charging device 512 may further be equipped with a display and a payment system. The display can be a touch screen display configured to receive information regarding EV user's charging needs and show current status of the charge. The payment system can determine the charge transferred, determine a monetary value, and provide the EV user with payment options.

In further embodiments, the charging station 508 may be equipped with an intermediary battery 510 interposed between the local power grid 502 and charging station capacitors 504. The intermediary battery 510 may allow the charging station 508 to store additional charge, which can be used in emergency situations such as power black outs, or stock up on additional charge when electricity costs are at its lowest.

FIG. 6A illustrates a block diagram of an exemplary induction based EV charging system 600 in accordance with some embodiments. This system may provide EV charging without physically connecting an EV to a charging device or an outlet. An advantage of such embodiments can be that they allow an EV to be charged in situations where it cannot remain stationary for an extended period of time.

In further embodiments, the induction based EV charging system can be adopted for use on regular roads. Road induction coils 604 may be installed under the road surface, allowing the EV 608 to be charged as it travels along the road.

In some embodiments, multiple road induction coils 604 may be placed under the driving surface 602 and coupled to the local power grid 606. Each EV 608 is equipped with a vehicle induction coil 612 and a battery 610. The battery 610 in the EV 608 will receive and store the charge that is transferred to the vehicle induction coil 612. A tracking system 614, may be coupled to the road induction coils 604. In some embodiments, the tracking system 614 may be implemented by an on-site server, such as the on-site server 214.

In some embodiments, the EV 608 may be equipped with a tracking device 616. The tracking system 614 may monitor and track the movement of the EV 608 via the tracking device 616 from one road induction coil 604 to another, and further monitors the amount of charge transferred to that particular EV 608. The tracking device 616 can be associated with an EV user's account. Charging bills that are associated with the EV user may be directly sent to the EV user's account, eliminating the need for the EV user to pay at the charging station. The tracking device 616 can be further associated with a company that owns or operates a fleet of EVs, such as a taxi or limousine company.

The tracking device can operate by providing token data to the system via the inductive charges. GPS or other position determination system may also be used for vehicle tracking. In further embodiments, the location of charging devices can be modulated with the charging signal, gathered by the vehicle and sent by communications systems in the vehicle to the system infrastructure for billing purposes.

In further embodiments, the EV 608 may not be equipped with a tracking device 616. In such embodiments, the tracking system 607 may identify and track the EV 608 without relying on a tracking device 616. For example, the tracking system 614 may track the EV 608 using cameras, or by measuring draw at the road induction coils 604. Additionally, the charging station can be equipped with an exit gate that prevents the EV 608 from leaving until payment is completed.

In some embodiments, the induction based EV charging system may be applied to taxi waiting areas 620 at airports or hotels, as depicted in FIG. 68. Taxis 608 in waiting areas 620 sometimes spend an extended period of time waiting customers, but do not necessarily remain stationary as they wait. As taxis 608 leave the waiting area 620 for their next clients, the taxi queue generally moves along. Due to this constant movement in the queue, it can be difficult for taxis 608 to connect to an electric charging device. However, by installing multiple road induction coils 604 underneath the taxi waiting area 620, in accordance with some embodiments, the taxis 608 can be charged while they wait for their next customers. Taxis can be billed a flat fee for this service, billed on a per use basis, billed based on the amount of waiting time (e.g., based on entry and exit times), or billed based on the amount of charge consumed.

FIGS. 7 and 8 illustrates a courtesy charging feature in connection with an exemplary centralized EV charging information display system 700 in accordance with some embodiments. The centralized EV charging information display system may be generally applied in a charging station environment, where it provides information regarding the current state of the EVs that are being charged. The courtesy feature may allow EV users arriving at the charging station to queue behind a first EV, disconnect the charging connector under the assumption that the first EV's charging needs have been satisfied, and begin charging their EV without the presence of the first EV owner. The system 700 may be controlled by a central terminal 704. The central terminal 704 may be coupled to a plurality of displays 702 and electric charging devices 706. The central terminal 704 may monitor information received from the electric charging devices 706 and transfer this information to the displays 702. The displays 702 may show information related to the current status of the charge of each electric charging devices 706 and a chronological list of the order of which electric charging device will become available.

In some embodiments 800, whether a different EV owner may disconnect a previous connection may generally be determined based on the charging needs that the first EV user provided before charging the EV at operation 802. The system may associate the EV with the electric charging device at operation 804 by retrieving EV identification information. The EV user may then couple the EV with the electric charging device and charging commences at operation 806. If an EV is not associated with the system, the system may not provide charge to the EV at operation 812. Once the user's charging needs are met at operation 804, charge transfer ceases and the EV and the electric charging device may be decoupled at operation 810. If the EV user's charging needs are not met, the system will continue to provide charge to the EV based on the EV user's charging needs.

In some embodiments, charges for vehicle charging can be tracked based on token ID (a user's token or a vehicle ID token) and charged back to the user through a centralized infrastructure. For example, the infrastructure can set up a billing and payment system for its users. As another example, the attribute management systems may be linked to the local utility to charge the vehicle charging fees to the user on his or her utility bill. In such embodiments, the token ID is used to associate the user with an account so charges can be accrued to the electric utility bill. Such systems can be used for individual accounts as well as for corporate, government or other group accounts, in a corporate, government or other group account, a further feature can be provided to allow use and charges to attributed to the joint account or the user's individual account. For example, a vehicle may be driven by it's user for business purposes as well as personal use. Accordingly, vehicle use, and the amount of charge consumed by the vehicle can be tracked based on time of day, driving location, or other information, so that the appropriate charges can be attributed to the proper account, whether the business account or the personal account. Therefore, the vehicle may have a charge use indicator coupled to a date/time system to track consumption based on date and time. Therefore, charges accrued during business and personal hours can be appropriately separated and billed to the corresponding account. Likewise, the consumption can be tied to the vehicle's navigation or other locational system, to track usage based on location. In this manner, charges accrued for certain routes can be charged to the business, while other routes can be charged to personal use. Also, such a system can be used to keep records of vehicle operational costs for tax, client billing, or other purposes.

As used herein, the term system might describe a given unit of functionality that can be performed in accordance with one or more embodiments of the present invention. As used herein, a system might be implemented utilizing any form of hardware, software, or a combination thereof. For example, one or more processors, controllers, ASICs, PLAs, PALs, CPLDs, FPGAs, logical components, software routines or other mechanisms might be implemented to make up a system. In implementation, the various systems described herein might be implemented as discrete systems or the functions and features described can be shared in part or in total among one or more systems. In other words, as would be apparent to one of ordinary skill in the art after reading this description, the various features and functionality described herein may be implemented in any given application and can be implemented in one or more separate or shared systems in various combinations and permutations. Even though various features or elements of functionality may be individually described or claimed as separate systems, one of ordinary skill in the art will understand that these features and functionality can be shared among one or more common software and hardware elements, and such description shall not require or imply that separate hardware or software components are used to implement such features or functionality.

Where components or systems of the invention are implemented in whole or in part using software, in some embodiments, these software elements can be implemented to operate with a computing or processing module capable of carrying out the functionality described with respect thereto. One such example computing system is shown in FIG. 9. Various embodiments are described in terms of this example-computing system 900. After reading this description, it will become apparent to a person skilled in the relevant art how to implement the invention using other computing systems or architectures.

Referring now to FIG. 9, computing system 900 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing system 900 might also represent computing capabilities embedded within or otherwise available to a given device. For example, a computing system might be found in other electronic devices such as, for example, digital cameras, navigation systems, cellular telephones, portable computing devices, modems, routers, WAPs, terminals and other electronic devices that might include some form of processing capability.

Computing system 900 might include, for example, one or more processors, controllers, control modules, or other processing devices, such as a processor 904. Processor 904 might be implemented using a general-purpose or special-purpose processing engine such as, for example, a microprocessor, controller, or other control logic. In the illustrated example, processor 904 is coupled to a bus 902, although any communication medium can be used to facilitate interaction with other components of computing system 900 or to communicate externally.

Computing system 900 might also include one or more memory modules, simply referred to herein as main memory 908. For example, preferably random access memory (RAM) or other dynamic memory, might be used for storing information and instructions to be executed by processor 904. Main memory 908 might also be used for storing temporary variables or other intermediate information during execution of instructions to be executed by processor 904. Computing system 900 might likewise include a read only memory (“ROM”) or other static storage device coupled to bus 902 for storing static information and instructions for processor 904.

The computing system 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a floppy disk drive, a magnetic tape drive, an optical disk drive, a CD or DVD drive (R or RW), or other removable or fixed media drive might be provided. Accordingly, storage media 914 might include, for example, a hard disk, a floppy disk, magnetic tape, cartridge, optical disk, a CD or DVD, or other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing system 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory module) and memory slot, a PCMCIA slot and card, and other fixed or removable storage units 922 and interfaces 920 that allow software and data to be transferred from the storage unit 922 to computing module 900.

Computing system 900 might also include a communications interface 924. Communications interface 924 might be used to allow software and data to be transferred between computing system 900 and external devices. Examples of communications interface 924 might include a modem or softmodem, a network interface (such as an Ethernet, network interface card, WiMedia, IEEE 802.XX or other interface), a communications port (such as for example, a USB port, IR port, RS232 port Bluetooth®, interface, or other port), or other communications interface. Software and data transferred via communications interface 924 might typically be carried on signals, which can be electronic, electromagnetic (which includes optical) or other signals capable of being exchanged by a given communications interface 924. These signals might be provided to communications interface 924 via a channel 928. This channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 908, storage unit 920, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing system 900 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A charging server comprising:
a controller; and
a memory storing instructions configured to be executed by the controller to cause the charging server to perform the steps of:
connecting to an electric charging device;
connecting to a charging management system;
receiving an authorization instruction to charge an electric vehicle using the electric charging device; and
controlling the electric charging device to charge the electric vehicle according to the authorization instruction.

2. The charging server of claim 1, wherein the instructions cause the charging server to perform the step of monitoring total on-site power usage.

3. The charging server of claim 2, wherein the instructions cause the charging server to perform the step of modulating the amount of charge provided to the electric vehicle to maintain a total on-site power usage below a threshold.

4. The charging server of claim 1, wherein:
the authorization instruction further comprises charging needs including speed of charging, duration of charging, level of charging, authorized price of electricity, completion time, or time of charging; and
the instructions cause the charging server to perform the step of controlling the electric charging device to charge the electric vehicle to fulfill the charging needs.

5. The charging server of claim 1, wherein the instructions cause the charging server to perform the step of receiving a token from a user or the electric vehicle.

6. The charging server of claim 5, wherein the instructions cause the charging server to perform the step of associating parking duration of the electric vehicle with the token.

7. The charging server of claim 5, wherein the token is received via the electric charging device.

8. The charging server of claim 5, wherein the token is received via the charging management system.

9. The charging server of claim 1, wherein the instructions cause the charging server to perform the step of transmitting charging data to the charging management system.

10. The charging server of claim 9, wherein the charging data include an amount of charge transferred to the electric vehicle, a charging status, a time spent charging, or a time spent by the electric vehicle connected to the electric charging device.

11. The charging server of claim 1, wherein the electric charging device comprises a capacitor.

12. The charging server of claim 11, wherein the instructions cause the charging server to manage the level of charge of the capacitor.

13. The charging server of claim 1, wherein the electric charging device comprises a battery.

14. The charging server of claim 13, wherein the instructions cause the charging server to manage the level of charge of the battery.

15. The charging server of claim 1, wherein the electric charging device comprises a plurality of induction coils disposed below a driving surface.

16. The charging server of claim 15, wherein the instructions cause the charging server to monitor the electric vehicle as it moves from one induction coil to another induction coil and to monitor the amount of charge transferred to the electric vehicle from each induction coil.

17. A charging management system, comprising:
a controller; and
a memory storing instructions configured to be executed by the controller to cause the charging server to perform the steps of:
connecting to a charging server;
connecting to an authorization management system;
receiving a charging request from a charging server, the charging request identifying an electric charging device requested to be used to charge an electric vehicle;
transmitting an authorization request to the authorization management system for the electric charging device to be used to charge the electric vehicle;
receiving an authorization response from the authorization management system authorizing the electric charging device to be used to charge the electric vehicle; and
transmitting an authorization instruction to the charging server to charge the electric vehicle using the electric charging device.

18. The charging, management system of claim 17, wherein the instructions cause the charging server to perform the step of receiving a token from a user or the electric vehicle.

19. The charging management system of claim 17, wherein the instructions cause the charging server to perform the step of receiving an indication of electric vehicle charging needs for the electric vehicle.

20. The charging management system of claim 19, wherein the indication of electric vehicle charging needs are received from a portable device of a user, the electric vehicle, or a website.

21. The charging management system of claim 20, wherein the electric vehicle charging needs include speed of charging, duration of charging, level of charging, authorized price of electricity, completion time, or time of charging.

22. The charging management system of claim 17, wherein the instructions cause the charging server to perform the step of receiving charging data from the charging server.

23. The charging management system of claim 22, wherein the charging data include an amount of charge transferred to the electric vehicle, a charging status, a time spent charging, or a time spent by the electric vehicle connected to the electric charging device.

24. A method, comprising:
connecting to an electric charging device;
connecting to a charging management system;
receiving an authorization instruction to charge an electric vehicle using the electric charging device; and
controlling the electric charging device to charge the electric vehicle according to the authorization instruction.

25. The method of claim 24, further comprising monitoring total on-site power usage.

26. The method of claim 25, further comprising modulating the amount of charge provided to the electric vehicle to maintain a total on-site power usage below a threshold.

27. The method of claim 24, wherein the authorization instruction further comprises charging needs including speed of charging, duration of charging, level of charging, authorized price of electricity, completion time, or time of charging; and further comprising controlling the electric charging device to charge the electric vehicle to fulfill the charging needs.

28. The method of claim 24, further comprising receiving a token from a user or the electric vehicle.

29. The method of claim 28, further comprising associating parking duration of the electric vehicle with the token.

30. The method of claim 28, wherein the token is received via the electric charging device.

31. The method of claim 28, wherein the token is received via the charging management system.

32. The method of claim 24, further comprising transmitting charging data to the charging management system.

33. The method of claim 32, wherein the charging data include an amount of charge transferred to the electric vehicle, a charging status, a time spent charging, or a time spent by the electric vehicle connected to the electric charging device.

34. The method of claim 24, wherein the electric charging device comprises a capacitor and further comprising managing the level of charge of the capacitor.

35. The method of claim 24, wherein the electric charging device comprises a battery and further comprising managing the level of charge of the battery.

36. The method of claim 24, wherein the electric charging device comprises a plurality of induction coils disposed below a driving surface; and further comprising monitoring the electric vehicle as it moves from one induction coil to another induction coil and to monitor the amount of charge transferred to the electric vehicle from each induction coil.

37. A method, comprising:
connecting to a charging server;
connecting to an authorization management system;
receiving a charging request from a charging server, the charging request identifying an electric charging device requested to be used to charge an electric vehicle;
transmitting an authorization request to the authorization management system for the electric charging device to he used to charge the electric vehicle;
receiving an authorization response from the authorization management system authorizing the electric charging device to be used to charge the electric vehicle; and
transmitting an authorization instruction to the charging server to charge the electric vehicle using the electric charging device.

38. The method of claim 37, further comprising receiving a token from a user or the electric vehicle.

39. The method of claim 38, wherein the indication of electric vehicle charging needs are received from a portable device of a user, the electric vehicle, or a website.

40. The method of claim 38, wherein the electric vehicle charging needs include speed of charging, duration of charging, level of charging, authorized price of electricity, completion time, or time of charging.

41. The method of claim 37, further comprising receiving charging data from the charging server.

42. The method of claim 41, wherein the charging data include an amount of charge transferred to the electric vehicle, a charging status, a time spent charging, or a time spent by the electric vehicle connected to the electric charging device.
